(19) United States
(12) Patent Application Publication
(10) Pub. No.: US 2012/0289640 A1
(43) Pub. Date: Nov. 15, 2012

(54) VIBRATION-ISOLATING RUBBER COMPOSITION

(75) Inventor: Toyohisa Tohyama, Toyoake-shi (JP)

(73) Assignee: TOKAI RUBBER INDUSTRIES, LTD., Komaki-shi (JP)

(21) Appl. No.: 13/561,709

(22) Filed: Jul. 30, 2012

Related U.S. Application Data
(63) Continuation of application No. PCT/JP2011/053277, filed on Feb. 16, 2011.

(30) Foreign Application Priority Data
Feb. 26, 2010 (JP) 2010-043045
Sep. 15, 2010 (JP) 2010-207167

(51) Int. Cl. C08L 9/00; C08K 3/10; C08K 3/26; C08K 3/36

(52) U.S. Cl. 524/424; 524/493; 524/456

(57) ABSTRACT

A vibration-isolating rubber composition contains components (A) and (B) below and components (C) and (D) below, wherein the amount of the component (B) added is 10 to 100 parts by weight relative to 100 parts by weight of the component (A); (A) diene rubber; (B) silica having all the properties (α), (β), and (γ); (α) a silanol group density of the silica surface of 3.0 groups/nm² or more as calculated by the Sears titration method, (β) an average particle diameter of 10 μm or less, and (γ) a BET specific surface area of 15 to 60 m²/g; (C) a silane coupling agent having a specific structure; and (D) at least one of zinc monomethacrylate and a specific mono(meth)acrylate. Therefore, the vibration-isolating rubber composition exhibits good heat resistance, durability, and stiffness and a reduced dynamic multiplication.

### TECHNICAL FIELD

The present invention relates to a vibration-isolating rubber composition and more specifically to a vibration-isolating rubber composition used for, for example, an engine mount having a function of supporting an engine of an automobile or the like and used for suppressing the transmission of vibration.

### BACKGROUND OF THE INVENTION

In general, a vibration-isolating rubber composition is used in automobiles for the purpose of reducing vibration and noise. Such a vibration-isolating rubber composition requires a high stiffness, a high strength, and an ability to suppress transmission of vibration. Therefore, it is necessary to reduce the value of dynamic multiplication [dynamic spring constant (Kd)/statistic spring constant (Ks)] (reduction in dynamic multiplication). Hitherto, as measures for reducing dynamic multiplication, for example, carbon black has been used as a reinforcing agent and factors such as the amount, the particle diameter, and the structure of the carbon black have been controlled. However, this has been insufficient for reducing dynamic multiplication. Therefore, vibration-isolating rubber compositions have been proposed which contain silica instead of carbon black functioning as a reinforcing agent, and thus have a lower dynamic multiplication as compared with rubber compositions containing carbon black (for example; Japanese Patent No. 3233458 and Japanese Unexamined Patent Application Publication No. 20004-168885). Furthermore, from the standpoint that silica having a large primary particle diameter (having a small BET specific surface area) is effective in reducing dynamic multiplication, for example, there has been proposed a vibration-isolating rubber composition containing 100 parts by weight of a rubber component containing natural rubber as a main component and 20 to 80 parts by weight of silica having a BET specific surface area of 25 to 100 m²/g and a Δ thermal weight loss rate defined as “a difference between a thermal weight loss rate at 1,000° C. and a thermal weight loss rate at 150° C. in thermogravimetric measurement” is 3.0% or more (Japanese Unexamined Patent Application Publication No. 2006-199899).

### SUMMARY OF THE INVENTION

The vibration-isolating rubber composition described in Japanese Unexamined Patent Application Publication No. 2006-199899 contains silica having a large primary particle diameter, and thus a reduction in dynamic multiplication can be effectively achieved as compared with the case where ordinary silica is used. However, the use of silica having a large primary particle diameter causes a reduction in the interaction between such silica and rubber, resulting in a problem of degradation of durability of the resulting vibration-isolating rubber. In addition, heat resistance is also necessary for a vibration-isolating rubber composition, however, the vibration-isolating rubber composition described in the above patent literature is insufficient in terms of heat resistance.

In general, an improvement in heat resistance of a vibration-isolating rubber composition is achieved by optimizing the amount of antioxidant added or the vulcanization system. However, this method may decrease durability and inhibit a reduction in dynamic multiplication.

Furthermore, recently, in order to effectively use a design space in an engine compartment and to realize application to compact vehicles, a reduction in size of an engine mount has been desired. However, when the size of an engine mount is reduced, the distortion factor for the vibration load increases, and thus durability cannot be ensured. Therefore, stiffness (hardness) of the engine mount itself is required.

As described above, in reality, a vibration-isolating rubber composition that can sufficiently satisfy requirements of heat resistance, durability, stiffness, and a reduction in dynamic multiplication has not yet been realized, and a further improvement may be achieved.

A vibration-isolating rubber composition is provided which exhibits good heat resistance, durability, and stiffness and a reduced dynamic multiplication.

The vibration-isolating rubber composition contains components (A) and (B) below and components (C) and (D) below, wherein the amount of the component (B) added is 10 to 100 parts by weight relative to 100 parts by weight of the component (A):

(A) diene rubber;
(B) silica having all the properties (α), (β), and (γ):

(α) a silanol group density of the silica surface of 3.0 groups/nm² or more as calculated by the Sears titration method,

(β) an average particle diameter of 10 μm or less, and

(γ) a BET specific surface area of 15 to 60 m²/g; (c) a silane coupling agent represented by general formula (1):

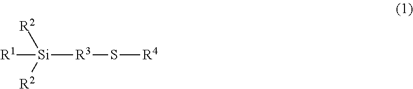

where R¹ represents an alkyl polyether group —O—(R⁵—O)ₘ—R⁶ (where m is 1 to 30 on average, R⁵s in the number m of repetitions may be the same or different and are each a hydrocarbon group having 1 to 30 carbon atoms, and R⁶ is a monovalent alkyl, alkenyl, aryl, or aralkyl group having at least 11 carbon atoms),

two R²s may be the same or different, and are each the same as R¹, an alkyl group having 1 to 12 carbon atoms, or an R⁷O group (where R⁷ is H, a methyl, ethyl, propyl, (R⁸)₃Si group (where R⁸ is an alkyl or alkenyl group having 1 to 30 carbon atoms), or a monovalent alkyl, alkenyl, aryl, or aralkyl group having 9 to 30 carbon atoms),

R³ is at least one divalent hydrocarbon group having 1 to 30 carbon atoms and selected from the group consisting of aliphatic, aromatic, and mixed aliphatic-aromatic groups, and

R⁴ is H, CN, or (C═O)—R⁹ (where R⁹ is at least one monovalent hydrocarbon group having 1 to 30 carbon atoms and selected from the group consisting of aliphatic, aromatic, and mixed aliphatic-aromatic groups); and

(D) at least one selected from the group consisting of zinc monomethacrylate, 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, N-acryloyloxyethyl hexahydrophthalimide, isobornyl methacrylate, tetrahydrofurfuryl acrylate, 2-phenoxyethyl methacrylate, ethoxylated (2) hydroxyethyl methacrylate, and isodecyl methacrylate.

Preparing a vibration-isolating rubber composition by mixing specific silica (component B) that has all the above properties of (α) to (γ) with diene rubber (component A) in a specific ratio, and further mixing a specific silane coupling agent (component C) represented by general formula (1) above and a specific vulcanization aid (component D) such as zinc monomethacrylate can result in obtaining a vibration isolating rubber composition that exhibits good heat resistance, durability and stiffness with a reduced dynamic multiplication.

Specifically, the silica used as the component (B) satisfies all the above-described conditions of (α) to (γ), thereby increasing dispersibility and increasing the reactivity with the diene rubber and the silane coupling agent. Thus, it was found that the incorporation of such silica in a specific ratio significantly contributes to the improvement in durability and a reduction in dynamic multiplication of the vibration-isolating rubber composition. The silane coupling agent used as the component (C) has a long-chain alkyl polyether group [preferably, —O—(CH₂CH₂O)ₘ—C₁₃H₂₇]. Accordingly, the incorporation of the silane coupling agent significantly improves dispersibility of the silica. Furthermore, even a small amount of the silane coupling agent can achieve the above advantage, and thus the amount of silane coupling agent added can be suppressed. The proportion of sulfur (S) in the silane coupling agent itself is small. Therefore, the total amount of sulfur in the vibration-isolating rubber composition can be suppressed, thereby achieving an advantage of the improvement in heat resistance. The specific vulcanization aid such as zinc monomethacrylate, which is the component (D), contributes to a significant improvement in heat resistance of the vibration-isolating rubber composition without decreasing durability and inhibiting a reduction in dynamic multiplication of the rubber composition.

As described above, the vibration-isolating rubber composition is obtained by mixing specific silica (component B) that has all the above properties of (α) to (γ) with diene rubber (component A) in a specific ratio, and further mixing a specific silane coupling agent (component C) and a specific vulcanization aid (component D) such as zinc monomethacrylate. Therefore, all heat resistance, durability, stiffness, and a reduction in dynamic multiplication can be highly satisfied. The vibration-isolating rubber composition containing the above components has, in particular, significantly improved heat resistance. Thus, the vibration-isolating rubber composition is suitably used as a vibration-isolating material of an engine mount, a stabilizer bush, a suspension bush, or the like, all of which are used in the body of an automobile or the like. Besides, the vibration-isolating rubber composition can also be used in applications of damping (vibration control) devices and seismic isolators, such as a vibration damper of a hard disk of computers, a vibration damper of general household electric appliances such as a washing machine, and a damping wall and a vibration damper (vibration controller) for architectural structures in the fields of architecture and houses.

### BRIEF DESCRIPTION OF THE DRAWINGS

The advantages of the invention will become apparent in the following description taken in conjunction with the drawings, wherein:

FIG. 1 is a schematic view illustrating an example of a chemical bonding state between a specific silane coupling agent and specific silica.

FIG. 2 is a schematic view illustrating another example of a chemical bonding state between a specific silane coupling agent and specific silica.

FIG. 3 is a schematic view illustrating still another example of a chemical bonding state between a specific silane coupling agent and specific silica.

### DETAILED DESCRIPTION OF THE INVENTION

Next, embodiments of the present invention will be described in detail.

A vibration-isolating rubber composition is obtained by mixing diene rubber (component A), specific silica (component B), a specific silane coupling agent (component C), and a specific vulcanization aid (component D) such as zinc monomethacrylate, and the amount of specific silica (component B) added is set to a specific proportion relative to the diene rubber (component A).

Examples of the diene rubber (component A) include natural rubber (NR), isoprene rubber (IR), butadiene rubber (BR), styrene-butadiene rubber (SBR), acrylonitrile-butadiene rubber (NBR), and ethylene-propylene-diene rubber (EPDM). These may be used alone or in combination of two or more thereof. Among these, natural rubber is preferably used from the standpoint of the strength and a reduction in dynamic multiplication.

Next, the specific silica (component B) used together with the diene rubber (component A) has all the properties (α), (β), and (γ) below:

(α) a silanol group density of the silica surface of 3.0 groups/nm² or more as calculated by the Sears titration method,

(β) an average particle diameter of 10 μm or less, and

(γ) a BET specific surface area of 15 to 60 m²/g.

First, the property (a) will be described. As described above, the silanol group density of the silica surface of the component (B) calculated by the Sears titration method is 3.0 groups/nm² or more, and preferably in the range of 3 to 30 groups/nm². The silanol group is a functional group serving as a bonding group with the silane coupling agent and also serving as a reactive group with the diene rubber. If the silanol group density is smaller than the specified range, the reactivity (bondability) with the silane coupling agent (component C) and the diene rubber (component A) is poor. Accordingly, durability tends to decrease, the silica does not sufficiently react with the silane coupling agent and the diene rubber, and physical properties of the resulting rubber also tend to decrease.

Herein, the silanol group density of the silica surface in the present invention can be calculated from the Sears titer measured by the method described in G. W. Sears, Analytical Chemistry, vol. 28, No. 12, 1956, 1982 to 1983. In the calculation of the silanol group density, the relationship between the Sears titer and the amount of silanol group is assumed to be derived from an ion-exchange reaction below.

Si—O—H+NaOH→Si—O—Na+H₂O

Examples of the method for calculating the silanol group density include a thermogravimetric (TG) method besides the Sears titration method. In the calculation of the silanol group density by the thermogravimetric (TG) method, heating loss in entirety thereof is counted as the loss of —OH groups. Accordingly, the —OH groups present in the inner portions of primary particles and micro-portions of silica aggregates having no interaction with rubber are also counted. In contrast, the determination of the silanol group density by the Sears titration method is a method for counting only —OH groups present on the surface of silica aggregates. In consideration of the distribution state of silica in the rubber and the bonding state of silica to the rubber, the silanol group density calculated by the Sears titration method is more preferable because a state close to the actual state is expressed by the Sears titration method.

Next, the property (β) specifies the average particle diameter of the silica used as the component (B). As described above, the average particle diameter of the silica used as the component (B) is 10 μm or less, and preferably in the range of 2 to 10 μm. When the average particle diameter is excessively larger than the specified value, aggregates become large and the silica itself acts as a foreign substance. Consequently, physical properties are degraded and dynamic multiplication is increased by the aggregation of the silica.

Herein, the term “average particle diameter” refers to an average particle diameter measured by the Coulter method, and refers to the secondary particle diameter.

Next, the property (γ) will be described. As described above, the BET specific surface area of the silica used as the component (B) is within the range of 15 to 60 m²/g, and preferably within the range of 15 to 35 m²/g. If the BET specific surface area of the silica is excessively smaller than the specified range, the primary particles diameter is excessively large and the contact area itself between each primary particle and the diene rubber (component (A)) decreases. As a result, a sufficient reinforcing effect cannot be obtained, and the tensile strength at break (TSb) and the elongation at break (Eb) are decreased. In contrast, if the BET specific surface area is excessively large (exceeds 60 m²/g), the primary particle diameter is excessively small and thus the primary particles are strongly aggregated. Consequently, the dispersibility of the silica is decreased and dynamic properties are degraded.

The BET specific surface area of the silica can be measured, for example, as follows. A sample is degassed at 200° C. for 15 minutes, and the BET specific surface area is then measured with a BET specific surface area analyzer (produced by Micro Data Co., Ltd., 4232-II) using mixed gas (N₂ 70%, He 30%) as an adsorption gas.

An example of the method for preparing the silica (component B) is a method using a reaction for obtaining precipitated silica. For example, the silica may be prepared in accordance with a method including neutralizing an aqueous alkali silicate solution (a commercially available aqueous sodium silicate solution) with a mineral acid and allowing silica to precipitate. Specifically, first, a predetermined amount of an aqueous sodium silicate solution with a predetermined concentration is charged into a reaction vessel, and a mineral acid is added to this aqueous solution under predetermined conditions (single addition reaction). Alternatively, sodium silicate and a mineral acid are added to a reaction solution, which is prepared by charging in advance a predetermined amount of hot water, over a predetermined time while the pH and temperature of the reaction solution are controlled (simultaneous addition method). Next, a precipitated silica slurry prepared by one of the above methods is filtered with a filtration system (for example, a filter press or a belt filter) that can perform cake washing and then washed, thereby removing by-product electrolytes. The obtained silica cake is then dried with a dryer. In general, this silica cake is converted into a slurry, and the slurry is then dried with a spray dryer. Alternatively, the silica cake may be dried in a stationary manner in a heating oven or the like in the form of a cake. The dried silica thus obtained is subsequently pulverized into particles having a predetermined average particle diameter using a pulverizer. If necessary, coarse particles are removed from the particles with a classifier, thus preparing silica. The purpose of the pulverization and classification operations is to adjust the average particle diameter and to remove the coarse particles. A pulverizing method (for example, a jet pulverizer or an impact pulverizer) is not particularly limited. As for the classifier, the classifying method (for example, a pneumatic method or a screening method) is also not particularly limited.

The amount of silica (component B) added is in the range of 10 to 100 parts by weight (hereinafter abbreviated as “parts”), preferably in the range of 20 to 70 parts relative to 100 parts of the diene rubber (component A). If the amount added is excessively small, a requirement of a reinforcing effect of a certain level tends not to be satisfied. On the other hand, if the amount added is excessively large, dynamic multiplication may be increased. In addition, since the amount of silica added is excessively large, the silica itself acts as a foreign substance and physical properties tend to be degraded.

Next, as the specific silane coupling agent (component C) used together with the components (A) and (B), a silane coupling agent represented by general formula (1) below is used.

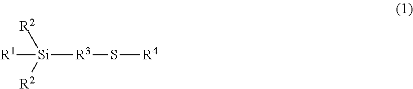

In the formula, R¹ represents an alkyl polyether group —O—(R⁵—O)ₘ—R⁶ (where m is 1 to 30 on average, R⁵s in the number m of repetitions may be the same or different and are each a hydrocarbon group having 1 to 30 carbon atoms, and R⁶ is a monovalent alkyl, alkenyl, aryl, or aralkyl group having at least 11 carbon atoms),

two R²s may be the same or different, and are each the same as R¹, an alkyl group having 1 to 12 carbon atoms, or an R⁷O group (where R⁵ is H, a methyl, ethyl, propyl, (R⁸)₃Si group (where R⁸ is an alkyl or alkenyl group having 1 to 30 carbon atoms), or a monovalent alkyl, alkenyl, aryl, or aralkyl group having 9 to 30 carbon atoms),

R³ is at least one divalent hydrocarbon group having 1 to 30 carbon atoms and selected from the group consisting of aliphatic, aromatic, and mixed aliphatic-aromatic groups, and

R⁴ is H, CN, or (C═O)—R⁹ (where R⁹ is at least one monovalent hydrocarbon group having 1 to 30 carbon atoms and selected from the group consisting of aliphatic, aromatic, and mixed aliphatic-aromatic groups).

The specific silane coupling agent (component C) preferably satisfies the length (the number of carbons) of R³ in general formula (1)<[the length (the number of carbons) of R⁶−(the length (the number of carbons) of R⁵×m)]

The specific silane coupling agent (component C) may be a mixture of various silane coupling agents represented by general formula (1) above or condensation products thereof.

The specific silane coupling agent (component C) is preferably a silane coupling agent represented by general formula (2) below, a silane coupling agent represented by general formula (3) below, or a mixture thereof.

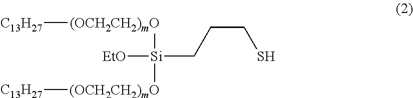

In the formula, m is the same as the above.

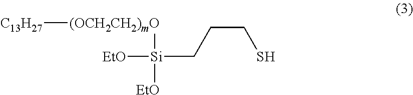

In the formula (3), m is the same as the above.

The specific silane coupling agent (component C) is particularly preferably a silane coupling agent represented by general formula (2) above, where m=5.

The amount of specific silane coupling agent (component C) added is preferably in the range of 0.5 to 10 parts, and particularly preferably in the range of 2 to 8 parts relative to 100 parts of the diene rubber (component A). If the amount of silane coupling agent added is excessively small, the effect of improving the dispersibility of silica decreases. On the other hand, if the amount of silane coupling agent added is excessively large, heat resistance tends to decrease.

Examples of the specific vulcanization aid (component D) used together with the components (A) to (C) include zinc monomethacrylate, 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, N-acryloyloxyethyl hexahydrophthalimide, isobornyl methacrylate, tetrahydrofurfuryl acrylate, 2-phenoxyethyl methacrylate, ethoxylated (2) hydroxyethyl methacrylate, and isodecyl methacrylate. These may be used alone or in combination of or more vulcanization aids. Among these, the use of zinc monomethacrylate in combination with a mono(meth)acrylate selected from 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobornyl methacrylate, tetrahydrofurfuryl acrylate, 2-phenoxyethyl methacrylate, and isodecyl methacrylate is preferable from the standpoint of excellent heat resistance (in particular, the effect of preventing heat aging). Note that the term “mono(meth)acrylate” refers to a monoacrylate or a monomethacrylate.

In a system that does not contain zinc monomethacrylate as the vulcanization aid used as the component (D), there may be a problem that the resulting rubber composition must be processed into a product immediately after kneading because of poor storage stability thereof. In such a case, from the standpoint of improving the storage stability, a metal (meth)acrylate is preferably incorporated in addition to the vulcanization aid used as the component (D). Examples of the metal (meth)acrylate include zinc monoacrylate, zinc dimethacrylate, and zinc diacrylate besides zinc monomethacrylate. These may be used alone or in combination of two or more metal (meth)acrylates.

The amount of specific vulcanization aid (component D) is preferably in the range of 0.5 to 10 parts, and particularly preferably in the range of 1 to 6 parts relative to 100 parts of the diene rubber (component A). If the amount of specific vulcanization aid added is smaller than the above range, a desired effect of preventing heat aging is not obtained. On the other hand, if the amount of specific vulcanization aid added exceeds the above range, the cross-linked state of the rubber composition changes, resulting in the degradation of a vibration isolation effect and setting resistance. In the case where a metal (meth)acrylate is incorporated in order to improve storage stability, the amount of metal (meth)acrylate is preferably in the range of 0.5 to 10 parts, and particularly preferably in the range of 1.0 to 6.0 parts relative to 100 parts of the diene rubber (component A).

In the vibration-isolating rubber composition, for example, the incorporation of zinc monomethacrylate provides an advantage of a significant increase in heat resistance as described above. On the other hand, in such a case, gas is generated to foam the vibration-isolating rubber composition, which may cause fusion failure of the vibration-isolating rubber composition and adhesion failure of the resulting vibration-isolating rubber (vulcanized product). As a method for solving this problem, for example, it is preferable to incorporate an adsorption filler such as zeolite, sepiolite, or hydrotalcite in addition to the components (A) to (D) into the vibration-isolating rubber composition. These adsorption fillers may be used alone or in combination of two or more fillers. It should be noted that, preferably, magnesium oxide, which is a typical adsorption filler, is not incorporated into the vibration-isolating rubber composition because degradation of heat resistance may occur. The zeolite is a substance in which some of silicon atoms in the crystal lattice composed of silicon dioxide are replaced with aluminum atoms, whereby the entire crystal lattice is negatively charged, and the charge is balanced by incorporating a cation of sodium, calcium, potassium, or the like. Examples of the zeolite include natural zeolite and synthetic zeolite synthesized so as to have the above composition. In view of gas adsorptivity, the composition of the zeolite preferably contains all the four elements of silicon, aluminum, sodium, and calcium.

The amount of adsorption filler added is preferably in the range of 2 to 15 parts, and particularly preferably in the range of 2 to 10 parts relative to 100 parts of the diene rubber (component A). If the amount of adsorption filler added is smaller than the above range, a desired effect of suppressing foaming is not obtained. On the other hand, if the amount of adsorption filler exceeds the above range, dynamic multiplication increases, and properties of the resulting vibration-isolating rubber degrade.

In the vibration-isolating rubber composition, not only the adsorption filler etc. described above but also a vulcanizing agent, a vulcanization accelerator, an antioxidant, process oil, carbon black, etc. may be appropriately mixed as required together with the components (A) to (D). In the vibration-isolating rubber composition, the specific silica (component B) is used instead of carbon black, which has been hitherto used as a reinforcing agent. Thus, preferably, the vibration-isolating rubber composition does not substantially contain carbon black as a reinforcing agent (carbon-black-free). However, carbon black may be contained in an amount that does not affect the properties of the vibration-isolating rubber composition.

Examples of the vulcanizing agent include sulfur (powder sulfur, precipitated sulfur, and insoluble sulfur). These may be used alone or in combination of two or more vulcanizing agents.

The amount of vulcanizing agent added is preferably in the range of 0.3 to 7 parts, and particularly preferably in the range of 1 to 5 parts relative to 100 parts of the diene rubber (component A). If the amount of vulcanizing agent added is excessively small, a satisfactory cross-linked structure is not obtained, and dynamic multiplication and setting resistance tend to degrade. On the other hand, if the amount of vulcanizing agent added is excessively large, heat resistance tends to decrease.

Examples of the vulcanization accelerator include thiazole-, sulfenamide-, thiuram-, aldehyde/ammonia-, aldehyde/amine-, guanidine-, and thiourea-based vulcanization accelerators. These may be used alone or in combination of two or more vulcanization accelerators. Among these, a sulfenamide-based vulcanization accelerator is preferable from the standpoint of high cross-linking reactivity thereof.

The amount of vulcanization accelerator added is preferably in the range of 0.5 to 7 parts, and particularly preferably in the range of 0.5 to 5 parts relative to 100 parts of the diene rubber (component A).

Examples of the thiazole-based vulcanization accelerators include dibenzothiazyl disulfide (MBTS), 2-mercaptobenzothiazole (MBT), sodium 2-mercaptobenzothiazole (NaMBT), and zinc 2-mercaptobenzothiazole (ZnMBT). These may be used alone or in combination of two or more compounds. Among these, dibenzothiazyl disulfide (MBTS) or 2-mercaptobenzothiazole (MBT) is preferably used from the standpoint of particularly high cross-linking reactivity thereof.

Examples of the sulfenamide-based vulcanization accelerators include N-oxydiethylene-2-benzothiazolyl sulfenamide (NOBS), N-cyclohexyl-2-benzothiazolyl sulfenamide (CBS), N-t-butyl-2-benzothiazolyl sulfenamide (BBS), and N,N′-dicyclohexyl-2-benzothiazolyl sulfonamide.

Examples of the thiuram-based vulcanization accelerators include tetramethylthiuram disulfide (TMTD), tetraethylthiuram disulfide (TETD), tetrabutylthiuram disulfide (TBTD), tetrakis(2-ethylhexyl)thiuram disulfide (TOT), and tetrabenzylthiuram disulfide (TBzTD).

Examples of the antioxidant include carbamate-based antioxidants, phenylenediamine-based antioxidants, phenol-based antioxidants, diphenylamine-based antioxidants, quinoline-based antioxidants, imidazole-based antioxidants, and waxes. These may be used alone or in combination of two or more antioxidants.

The amount of antioxidant added is preferably in the range of 1 to 10 parts, and particularly preferably in the range of 2 to 5 parts relative to 100 parts of the diene rubber (component A).

Examples of the process oil include naphthenic oil, paraffinic oil, and aromatic oil. These may be used alone or in combination of two or more oils.

The amount of process oil added is preferably in the range of 1 to 50 parts, and particularly preferably in the range of 3 to 30 parts relative to 100 parts of the diene rubber (component A).

The vibration-isolating rubber composition can be prepared, for example, as follows. The diene rubber (component A), the specific silica (component B), the specific silane coupling agent (component C), the specific vulcanization aid (component D), and if necessary, an antioxidant, process oil, etc. are appropriately mixed. Kneading of the resulting mixture is started with a Banbury mixer or the like from a temperature of about 50° C., and kneading is performed at 100° C. to 160° C. for about 3 to 5 minutes. Next, a vulcanizing agent, a vulcanization accelerator, and the like are appropriately mixed with the kneaded product. The resulting mixture is kneaded with an open roll mill under predetermined conditions (for example, at 50° C. for four minutes), thus preparing a vibration-isolating rubber composition. Subsequently, the prepared vibration-isolating rubber composition is vulcanized at a high temperature (150° C. to 170° C.) for 5 to 30 minutes, thereby preparing vibration-isolating rubber.

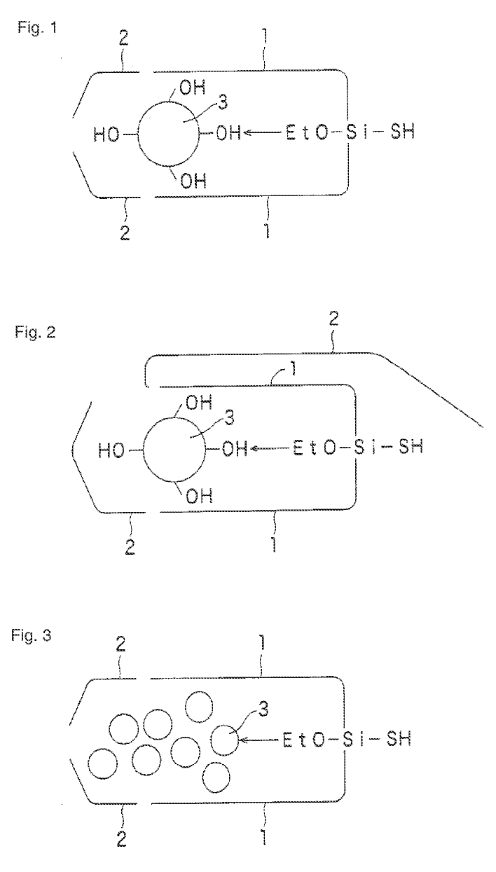

Here, a chemical bond between the specific silane coupling agent (component C) and the specific silica (component B) will be specifically described using, as an example, a silane coupling agent represented by general formula (2) above. For example, as illustrated in the schematic figure of FIG. 1, an EtO group (ethoxy group) in the silane coupling agent is chemically bonded to an OH group of the surface of silica 3. As a result, long-chain alkyl polyether groups [—O—(CH₂CH₂O)ₘ—C₁₃H₂₇] (bonding groups each indicated by reference numerals 1 and 2 in the figure) in the silane coupling agent substantially enclose the entire silica 3. As illustrated in FIG. 2, one of the long-chain alkyl polyether groups [—O—(CH₂CH₂O)ₘ—C₁₃H₂₇] (a bonding group indicated by reference numerals 1 and 2 in the figure) in the silane coupling agent may bend from a —C₁₃H₂₇ moiety (indicated by reference numeral 2 in the figure) located at the leading end of the bonding group to the opposite side by about 180°. FIG. 3 is a schematic view illustrating a chemical bonding state between a plurality of particles of silica 3 (where OH groups on the surfaces thereof are omitted) and a specific silane coupling agent. That is, dispersibility of the silica (component B) is improved by the above bond. Thus, the amount of specific silane coupling agent (component C) added can be suppressed. Consequently, dynamic multiplication of the vibration-isolating rubber composition can be reduced, and the total amount of sulfur in the vibration-isolating rubber composition can be suppressed to improve heat resistance.

### EXAMPLES

Next, Examples will be described in conjunction with Comparative Examples. It should be noted that the present invention is not limited to the Examples.

First, prior to Examples and Comparative Examples, materials described below were prepared.

### [NR]

Natural rubber

### [BR]

Butadiene rubber (Nipol BR1220, produced by Zeon Corporation)

### [Zinc Oxide]

Two types of zinc oxide, produced by Sakai Chemical Industry Co., Ltd.

### [Stearic Acid]

LUNAC S30, produced by Kao Corporation

### [Antioxidant]

OZONONE 6C, produced by Seiko Chemical Co., Ltd.

### [Wax]

SUNNOC produced by Ouchi Shinko Chemical Industrial Co., Ltd.

### [Mineral Oil]

Naphthenic oil (produced by Idemitsu Kosan Co., Ltd., Diana Process NM-280)

[Silane Coupling Agent (i)]

Silane coupling agent represented by general formula (2) above, where m is 5 (produced by Evonik Degussa, VPSi363)

[Silane Coupling Agent (ii)]

Mercapto-silane coupling agent represented by structural formula (4) below (KBM-803, produced by Shin-Etsu Chemical Co., Ltd.)

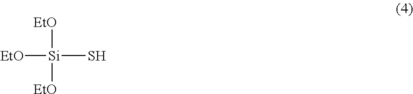

[Silica (i)]

Silica having a silanol group density of 10.1 groups/nm², an average particle diameter of 5.7 μm, and a BET specific surface area of 20 m²/g (TB5012, produced by Tosoh Silica Corporation)

[Silica (ii)]

Silica prepared so as to have a silanol group density of 14.4 groups/nm², an average particle diameter of 5 μm, and a BET specific surface area of 15 m²/g (Trial product)

[Silica (iii)]

Silica prepared so as to have a silanol group density of 3.0 groups/nm², an average particle diameter of 10 μm, and a BET specific surface area of 60 m²/g (Trial product)

[Silica (iv)]

Silica having a silanol group density of 2.4 groups/nm², an average particle diameter of 12 μm, and a BET specific surface area of 92 m²/g (Nipsil ER, produced by Tosoh Silica Corporation)

[Silica (v)]

Silica having a silanol group density of 2.6 groups/nm², an average particle diameter of 20 μm, and a BET specific surface area of 210 m²/g (Nipsil VN3, produced by Tosoh Silica Corporation)

[Adsorption Filler (i)]

Synthetic zeolite (MIZUKASIEVES SAP, produced by Mizusawa Industrial Chemicals, Ltd.)

[Adsorption Filler (ii)]

Synthetic zeolite (MIZUKALIZER DS, produced by Mizusawa Industrial Chemicals, Ltd.)

[Adsorption Filler (iii)]

Hydrotalcite (DHT4A, produced by Kyowa Chemical Industry Co., Ltd.)

[Vulcanization Accelerator (i)]

N-Cyclohexyl-2-benzothiazolyl sulfenamide (CBS) (NOCCELER CZ, produced by Ouchi Shinko Chemical Industrial Co., Ltd.)

[Vulcanization Accelerator (ii)]

Tetramethylthiuram disulfide (TMTD) (SANCELER TT, produced by Sanshin Chemical Industry Co., Ltd.)

### [Vulcanizing Agent]

Sulfur, produced by Karuizawa Seiren-sho

[Vulcanization Aid (i)]

Zinc monomethacrylate (PRO11542, produced by Sartomer Company, Inc.)

[Vulcanization Aid (ii)]

2-tert-Butyl-6-(3-tert-butyl-2-hydroxy-5-methylbenzyl)-4-methylphenyl acrylate (SUMILIZER GM, produced by Sumitomo Chemical Co., Ltd.)

[Vulcanization Aid (iii)]

Stearyl methacrylate (SR324, produced by Sartomer Company, Inc.)

[Vulcanization Aid (iv)]

Tridecyl methacrylate (SR493, produced by Sartomer Company, Inc.)

[Vulcanization Aid (v)]

Polypropylene glycol monomethacrylate (SR604, produced by Sartomer Company, Inc.)

[Vulcanization Aid (vi)]

Phenol EO-modified acrylate (M101A, produced by Toagosei Co., Ltd.)

[Vulcanization Aid (vii)]

Nonylphenol EO-modified acrylate (M111, produced by Toagosei Co., Ltd.)

[Vulcanization Aid (viii)]

N-Acryloyloxyethyl hexahydrophthalimide (M140, produced by Toagosei Co., Ltd.)

[Vulcanization Aid (ix)]

Isobornyl methacrylate (SR423, produced by Sartomer Company, Inc.)

[Vulcanization Aid (x)]

Tetrahydrofurfuryl acrylate (SR285, produced by Sartomer Company, Inc.)

[Vulcanization Aid (xi)]

2-Phenoxyethyl methacrylate (SR340, produced by Sartomer Company, Inc.)

[Vulcanization Aid (xii)]

Ethoxylated (2) hydroxyethyl methacrylate (SR570, produced by Sartomer Company, Inc.)

[Vulcanization Aid (xiii)]

Isodecyl methacrylate (SR242, produced by Sartomer Company, Inc.)

[Vulcanization Aid (xiv)]

Ethoxypolyethylene glycol (550) monomethacrylate (SR552, produced by Sartomer Company, Inc.)

[Vulcanization Aid (xv)]

Lauryl methacrylate (SR313, produced by Sartomer Company, Inc.)

### Example 1

First, 100 parts of NR, 5 parts of zinc oxide, 1 part of stearic acid, 2 parts of the antioxidant, 2 parts of the wax, 5 parts of the mineral oil, 2 parts of the silane coupling agent (i), 30 parts of the silica (i), and 3 parts of the vulcanization aid (i) were mixed, and the resulting mixture was kneaded with a Banbury mixer at 140° C. for five minutes. Next, 1 part of the vulcanizing agent, 2 parts of the vulcanization accelerator (i), and 1 part of the vulcanization accelerator (ii) were mixed thereto, and the resulting mixture was kneaded with an open roll mill at 60° C. for five minutes. Thus, a vibration-isolating rubber composition was prepared.

### Examples 2 to 34 and comparative examples 1 to 7

Vibration-isolating rubber compositions were prepared as in Example 1 except that, for example, the amounts of components added were changed as shown in Tables 1 to 5 below.

Properties of the vibration-isolating rubber compositions of Examples and Comparative Examples thus prepared were evaluated on the basis of the criteria described below. The results are also shown in Tables 1 to 5 below.

### [Heat Aging Test]

Each of the vibration-isolating rubber compositions was press-formed (vulcanized) at 160° C. for 20 minutes to prepare a rubber sheet having a thickness of 2 mm. The rubber sheet was punched to form a JIS No. 5 dumbbell. The elongation at break (Eb) was measured using this dumbbell in accordance with JIS K 6251. This measurement was conducted for an initial rubber sheet (before heat aging), a rubber sheet after heat aging in an atmosphere at 100° C. for 70 hours, a rubber sheet after heat aging in an atmosphere at 100° C. for 500 hours, and a rubber sheet after heat aging in an atmosphere at 100° C. for 1,000 hours. The degree of reduction (the difference from the initial state) in the elongation at break for each heat aging time was determined, and the values are shown in Tables 1 to 5 below. In this test, the degree of reduction in the elongation at break after heating, the degree of reduction being required, is 10.0% or less after heat aging for 70 hours, 40.0% or less after heat aging for 500 hours, and 60.0% or less after heat aging for 1,000 hours. A sample that satisfied all these requirements is denoted by “A”, and a sample that did not satisfy all these requirements is denoted by “B” in the comprehensive evaluation shown in Tables 1 to 5 below.

### [Compression Set]

Each of the vibration-isolating rubber compositions was press-formed (vulcanized) at 160° C. for 30 minutes to prepare a test piece. Next, in accordance with JIS K6262, the test piece was heated at 100° C. for 500 hours while the test piece was compressed by 25%. The compression set of the resulting test piece was then measured. In this test, the compression set which is required is less than 55%. A sample that satisfied this requirement is denoted by “A”, and a sample that did not satisfy this requirement is denoted by “B” in the evaluation shown in Tables 1 to 5 below.

### [Hardness (JIS-A)]

A test piece (thickness: 2 mm) specified in the “durometer hardness test” in the “method for physical test of vulcanized rubber” of JIS K6253-1997 was prepared using each of the vibration-isolating rubber compositions. A hardness (JIS-A) of the test piece was measured with a type A durometer in accordance with the “durometer hardness test” in the “method for physical test of vulcanized rubber” specified in JIS K6253-1997.

TABLE 1
(Parts by weight)

| | | Examples | | | | | | | | | |
|---|---|---|---|---|---|---|---|---|---|---|---|
| | | 1 | 2 | 3 | 4 | 5 | 6 | 7 | 8 | 9 | 10 |
| NR | | 100 | 100 | 100 | 100 | 100 | 100 | 100 | 100 | 100 | 100 |
| Zinc oxide | | 5 | 5 | 5 | 5 | 5 | 5 | 5 | 5 | 5 | 5 |
| Stearic acid | | 1 | 1 | 1 | 1 | 1 | 1 | 1 | 1 | 1 | 1 |
| Antioxidant | | 2 | 2 | 2 | 2 | 2 | 2 | 2 | 2 | 2 | 2 |
| Wax | | 2 | 2 | 2 | 2 | 2 | 2 | 2 | 2 | 2 | 2 |
| Mineral oil | | 5 | 5 | 5 | 5 | 5 | 5 | 5 | 5 | 5 | 5 |
| Silane coupling | Amount added | 2 | 2 | 2 | 2 | 2 | 2 | 2 | 2 | 2 | 2 |
| agent | Type | i | i | i | i | i | i | i | i | i | i |
| Silica | Amount added | 30 | 30 | 30 | 30 | 30 | 30 | 30 | 30 | 30 | 30 |
| | Type | i | i | i | i | i | i | i | i | i | i |
| Vulcanization accelerator (i) | | 2 | 2 | 2 | 2 | 2 | 2 | 2 | 2 | 2 | 2 |
| Vulcanization accelerator (ii) | | 1 | 1 | 1 | 1 | 1 | 1 | 1 | 1 | 1 | 1 |
| Vulcanizing agent | | 1 | 1 | 1 | 1 | 1 | 1 | 1 | 1 | 1 | 1 |
| Vulcanization | Amount added | 3 | 3 | 3 | 3 | 3 | 3 | 3 | 3 | 3 | 3 |
| aid | Type | i | ii | iii | iv | v | vi | vii | viii | ix | x |
| Heat | After 70 hours | 5 | 6 | 7 | 7 | 7 | 7 | 7 | 7 | 7 | 7 |
| aging test | After 500 hours | 31 | 33 | 34 | 33 | 33 | 33 | 33 | 33 | 33 | 33 |
| (%) | After 1,000 hours | 53 | 58 | 59 | 58 | 60 | 60 | 60 | 60 | 60 | 60 |
| | Comprehensive | A | A | A | A | A | A | A | A | A | A |
| | evaluation | | | | | | | | | | |
| Compression set (%) | | 46 | 35 | 43 | 49 | 43 | 43 | 43 | 43 | 46 | 48 |
| | Evaluation | A | A | A | A | A | A | A | A | A | A |

| | | | | | | | | | | |
|---|---|---|---|---|---|---|---|---|---|---|
| Hardness (JIS-A) | 50 | 50 | 50 | 50 | 50 | 50 | 50 | 50 | 50 | 50 |

TABLE 2

| | | | | | | (Parts by weight) | | | |
|---|---|---|---|---|---|---|---|---|---|
| | | Examples | | | | | | | |
| | | 11 | 12 | 13 | 14 | 15 | 16 | 17 | 18 |
| NR | | 100 | 100 | 100 | 100 | 100 | 100 | 100 | 80 |
| BR | | — | — | — | — | — | — | — | 20 |
| Zinc oxide | | 5 | 5 | 5 | 5 | 5 | 5 | 5 | 5 |
| Stearic acid | | 1 | 1 | 1 | 1 | 1 | 1 | 1 | 1 |
| Antioxidant | | 2 | 2 | 2 | 2 | 2 | 2 | 2 | 2 |
| Wax | | 2 | 2 | 2 | 2 | 2 | 2 | 2 | 2 |
| Mineral oil | | 5 | 5 | 5 | 5 | 5 | 5 | 5 | 5 |
| Silane coupling | Amount added | 2 | 2 | 2 | 2 | 2 | 2 | 2 | 2 |
| agent | Type | i | i | i | i | i | i | i | i |
| Silica | Amount added | 30 | 30 | 30 | 30 | 30 | 10 | 100 | 30 |
| | Type | i | i | i | ii | iii | i | i | i |
| Vulcanization accelerator (i) | | 2 | 2 | 2 | 2 | 2 | 2 | 2 | 2 |
| Vulcanization accelerator (ii) | | 1 | 1 | 1 | 1 | 1 | 1 | 1 | 1 |
| Vulcanizing agent | | 1 | 1 | 1 | 1 | 1 | 1 | 1 | 1 |
| Vulcanization | Amount added | 3 | 3 | 3 | 3 | 3 | 3 | 3 | 3 |
| aid | Type | xi | xii | xiii | i | i | i | i | i |
| Heat | After 70 hours | 7 | 7 | 7 | 5 | 5 | 5 | 7 | 5 |
| aging test | After 500 hours | 33 | 33 | 33 | 31 | 31 | 30 | 34 | 31 |
| (%) | After 1,000 hours | 60 | 60 | 60 | 53 | 53 | 52 | 59 | 53 |
| | Comprehensive | A | A | A | A | A | A | A | A |
| | evaluation | | | | | | | | |
| Compression set (%) | | 48 | 48 | 48 | 46 | 46 | 45 | 45 | 41 |
| | Evaluation | A | A | A | A | A | A | A | A |

| | | | | | | | | |
|---|---|---|---|---|---|---|---|---|
| Hardness (JIS-A) | 50 | 50 | 50 | 48 | 52 | 45 | 70 | 50 |

TABLE 3

| | | | | | | | | (Parts by weight) | | | |
|---|---|---|---|---|---|---|---|---|---|---|---|
| | | Examples | | | | | | | | | |
| | | 19 | 20 | 21 | 22 | 23 | 24 | 25 | 26 | 27 | 28 |
| NR | | 100 | 100 | 100 | 100 | 100 | 100 | 100 | 100 | 100 | 100 |
| Zinc oxide | | 5 | 5 | 5 | 5 | 5 | 5 | 5 | 5 | 5 | 5 |
| Stearic acid | | 1 | 1 | 1 | 1 | 1 | 1 | 1 | 1 | 1 | 1 |
| Antioxidant | | 2 | 2 | 2 | 2 | 2 | 2 | 2 | 2 | 2 | 2 |
| Wax | | 2 | 2 | 2 | 2 | 2 | 2 | 2 | 2 | 2 | 2 |
| Mineral oil | | 5 | 5 | 5 | 5 | 5 | 5 | 5 | 5 | 5 | 5 |
| Silane coupling | Amount added | 2 | 2 | 2 | 2 | 2 | 2 | 2 | 2 | 2 | 2 |
| agent | Type | i | i | i | i | i | i | i | i | i | i |
| Silica | Amount added | 30 | 30 | 30 | 30 | 30 | 30 | 30 | 30 | 30 | 30 |
| | Type | i | i | i | i | i | i | i | i | i | i |
| Vulcanization accelerator (i) | | 2 | 2 | 2 | 2 | 2 | 2 | 2 | 2 | 2 | 2 |
| Vulcanization accelerator (ii) | | 1 | 1 | 1 | 1 | 1 | 1 | 1 | 1 | 1 | 1 |
| Vulcanizing agent | | 1 | 1 | 1 | 1 | 1 | 1 | 1 | 1 | 1 | 1 |
| Vulcanization | Amount added | 3 | 3 | 3 | 3 | 3 | 3 | 3 | 3 | 3 | 3 |
| aid | Type | i | i | i | i | i | i | i | i | i | i |
| Vulcanization | Amount added | 3 | 3 | 3 | 3 | 3 | 3 | 3 | 3 | 3 | 3 |
| aid | Type | ii | iii | iv | v | vi | vii | ix | x | xi | xiii |
| Heat | After 70 hours | 5 | 5 | 5 | 5 | 5 | 5 | 5 | 5 | 5 | 5 |
| aging test | After 500 hours | 31 | 31 | 31 | 31 | 31 | 31 | 31 | 31 | 31 | 31 |
| (%) | After 1,000 hours | 56 | 57 | 56 | 56 | 58 | 57 | 57 | 58 | 58 | 58 |
| | Comprehensive | A | A | A | A | A | A | A | A | A | A |
| | evaluation | | | | | | | | | | |
| Compression set (%) | | 43 | 46 | 49 | 46 | 46 | 46 | 49 | 50 | 51 | 51 |
| | Evaluation | A | A | A | A | A | A | A | A | A | A |

| | | | | | | | | | | |
|---|---|---|---|---|---|---|---|---|---|---|
| Hardness (JIS-A) | 50 | 50 | 50 | 50 | 50 | 50 | 50 | 50 | 50 | 50 |

TABLE 4

| | | | | (Parts by weight) | | | |
|---|---|---|---|---|---|---|---|
| | | Examples | | | | | |
| | | 29 | 30 | 31 | 32 | 33 | 34 |
| NR | | 100 | 100 | 100 | 100 | 100 | 100 |
| Zinc oxide | | 5 | 5 | 5 | 5 | 5 | 5 |
| Stearic acid | | 1 | 1 | 1 | 1 | 1 | 1 |
| Antioxidant | | 2 | 2 | 2 | 2 | 2 | 2 |
| Wax | | 2 | 2 | 2 | 2 | 2 | 2 |
| Mineral oil | | 5 | 5 | 5 | 5 | 5 | 5 |
| Silane coupling | Amount added | 2 | 2 | 2 | 2 | 2 | 2 |
| agent | Type | i | i | i | i | i | i |
| Silica | Amount added | 30 | 30 | 30 | 30 | 30 | 30 |
| | Type | i | i | i | i | i | i |
| Adsorption filler | Amount added | 2 | 15 | 10 | 15 | 10 | 15 |
| | Type | i | i | ii | ii | iii | iii |
| Vulcanization accelerator (i) | | 2 | 2 | 2 | 2 | 2 | 2 |
| Vulcanization accelerator (ii) | | 1 | 1 | 1 | 1 | 1 | 1 |
| Vulcanizing agent | | 1 | 1 | 1 | 1 | 1 | 1 |
| Vulcanization | Amount added | 3 | 3 | 3 | 3 | 3 | 3 |
| aid | Type | i | i | i | i | i | i |
| Heat | After 70 hours | 3 | 3 | 4 | 3 | 3 | 4 |
| aging test | After 500 hours | 25 | 21 | 29 | 25 | 26 | 21 |
| (%) | After 1,000 hours | 43 | 38 | 51 | 48 | 45 | 37 |
| | Comprehensive | A | A | A | A | A | A |
| | evaluation | | | | | | |
| Compression set (%) | | 47 | 47 | 47 | 47 | 47 | 47 |
| | Evaluation | A | A | A | A | A | A |

| | | | | | | |
|---|---|---|---|---|---|---|
| Hardness (JIS-A) | 50 | 51 | 51 | 52 | 51 | 52 |

TABLE 5

| | | | | | (Parts by weight) | | | |
|---|---|---|---|---|---|---|---|---|
| | | Comparative Examples | | | | | | |
| | | 1 | 2 | 3 | 4 | 5 | 6 | 7 |
| NR | | 100 | 100 | 100 | 100 | 100 | 100 | 100 |
| Zinc oxide | | 5 | 5 | 5 | 5 | 5 | 5 | 5 |
| Stearic acid | | 1 | 1 | 1 | 1 | 1 | 1 | 1 |
| Antioxidant | | 2 | 2 | 2 | 2 | 2 | 2 | 2 |
| Wax | | 2 | 2 | 2 | 2 | 2 | 2 | 2 |
| Mineral oil | | 5 | 5 | 5 | 5 | 5 | 5 | 5 |
| Silane coupling | Amount added | 2 | 2 | 2 | 2 | 2 | 2 | 2 |
| agent | Type | i | i | ii | i | i | i | i |
| Silica | Amount added | 30 | 30 | 30 | 7 | 110 | 30 | 30 |
| | Type | i | i | i | i | i | iv | v |
| Vulcanization accelerator (i) | | 2 | 2 | 2 | 2 | 2 | 2 | 2 |
| Vulcanization accelerator (ii) | | 1 | 1 | 1 | 1 | 1 | 1 | 1 |
| Vulcanizing agent | | 1 | 1 | 1 | 1 | 1 | 1 | 1 |
| Vulcanization | Amount added | 3 | 3 | 3 | 3 | 3 | 3 | 3 |
| aid | Type | xiv | xv | i | i | i | i | i |
| Heat | After 70 hours | 7 | 7 | 10 | 8 | 15 | 6 | 7 |
| aging test | After 500 hours | 48 | 43 | 40 | 35 | 46 | 32 | 33 |
| (%) | After 1,000 hours | 66 | 62 | 68 | 57 | 75 | 55 | 58 |
| | Comprehensive | B | B | B | A | B | A | A |
| | evaluation | | | | | | | |
| Compression set (%) | | 46 | 47 | 55 | 54 | 58 | 55 | 57 |
| | Evaluation | A | A | B | A | B | B | B |

| | | | | | | | |
|---|---|---|---|---|---|---|---|
| Hardness (JIS-A) | 50 | 50 | 50 | 44 | 72 | 55 | 58 |

The above results show that samples of Examples are excellent in terms of compression set property and curing property. Furthermore, the results of the heat aging test show that the property of the elongation at break does not tend to degrade even after long heat aging. In particular, Examples 19 to 28, which contain, as vulcanization aids, a specific mono(meth)acrylate in combination with zinc monomethacrylate are excellent in terms of the effect of preventing heat aging.

In contrast, in Comparative Examples 1 and 2, a vulcanization aid that was different from the vulcanization aid of the Examples was used, and thus heat resistance (property of preventing heat aging) was degraded. In Comparative Example 3, since the silane coupling agent was a common mercapto-silane coupling agent, which was different from the silane coupling agent, heat resistance and compression set were degraded. In Comparative Example 4, since the amount of silica added was excessively small, heat resistance and compression set were slightly degraded. Furthermore, a desired rubber hardness was not obtained, and the reinforcing effect and spring stiffness were not ensured. In addition, after vulcanization forming, the sample was shrunk by cooling, and a problem in terms of shape and dimension also occurred. In Comparative Example 5, since the amount of silica added was excessively large, heat resistance and compression set were degraded. In Comparative Examples 6 and 7, since the silanol group density and the average particle diameter of the silica were out of the specified ranges (furthermore, in Comparative Example 6, the BET specific surface area was also out of the range), compression set was degraded.

Next, storage stability of each of the vibration-isolating rubber compositions of Examples was evaluated in accordance with the criteria below. The results are combined and shown in Tables 6 to 9 below.

### [Storage Stability]

In order to examine a change with time in the viscosity of each of the above-prepared rubber compositions in the unvulcanized state, the Mooney viscosities (ML₁₊₄ 121° C.) immediately after the resin composition was prepared (initial), after the resin composition was left to stand in a room-temperature, normal-humidity atmosphere for 72 hours (after storage), and after the resin composition was left to stand in an atmosphere at a temperature of 40° C. and at a humidity of 95% RH for 168 hours (after humid heat storage) were measured with a Mooney viscometer produced by Toyo Seiki Seisaku-sho, Ltd.

TABLE 6

| | | Examples | | | | | | | | | |
|---|---|---|---|---|---|---|---|---|---|---|---|
| | | 1 | 2 | 3 | 4 | 5 | 6 | 7 | 8 | 9 | 10 |
| Storage | Initial | 40 | 38 | 39 | 36 | 38 | 38 | 36 | 38 | 41 | 40 |
| stability | After storage | 42 | 45 | 43 | 44 | 46 | 46 | 44 | 46 | 49 | 49 |
| (ML₁₊₄ | After humid | 42 | 118 | 121 | 112 | 118 | 118 | 112 | 118 | 127 | 124 |
| 121° C.) | heat storage | | | | | | | | | | |

TABLE 7

| | | Examples | | | | | | | |
|---|---|---|---|---|---|---|---|---|---|
| | | 11 | 12 | 13 | 14 | 15 | 16 | 17 | 18 |
| Storage | Initial | 39 | 38 | 42 | 42 | 45 | 25 | 82 | 39 |
| stability | After storage | 48 | 46 | 49 | 45 | 47 | 26 | 85 | 42 |
| (ML₁₊₄ | After humid | 121 | 118 | 130 | 46 | 47 | 27 | 90 | 44 |
| 121° C.) | heat storage | | | | | | | | |

TABLE 8

| | | Examples | | | | | | | | | |
|---|---|---|---|---|---|---|---|---|---|---|---|
| | | 19 | 20 | 21 | 22 | 23 | 24 | 25 | 26 | 27 | 28 |
| Storage | Initial | 41 | 42 | 39 | 41 | 41 | 39 | 44 | 43 | 42 | 45 |
| stability | After storage | 42 | 44 | 41 | 43 | 43 | 42 | 47 | 46 | 47 | 49 |
| (ML₁₊₄ | After humid | 43 | 45 | 41 | 43 | 43 | 41 | 47 | 46 | 45 | 48 |
| 121° C.) | heat storage | | | | | | | | | | |

TABLE 9

| | | Examples | | | | | |
|---|---|---|---|---|---|---|---|
| | | 29 | 30 | 31 | 32 | 33 | 34 |
| Storage | Initial | 40 | 50 | 45 | 50 | 46 | 50 |
| stability | After storage | 42 | 53 | 47 | 53 | 49 | 53 |
| (ML₁₊₄ | After humid | 42 | 53 | 47 | 53 | 49 | 53 |
| 121° C.) | heat storage | | | | | | |

Referring to the above results, among the samples of Examples, in particular, in the samples (the sample of Example 1 and the samples of Examples 14 to 34) in which zinc monomethacrylate, i.e., the vulcanization aid (i) was used, the change in the viscosity was smaller than that of samples of other Examples even after the humid heat storage, and thus these samples had good storage stability. Although not shown in the table, among the samples in which zinc monomethacrylate was used, vulcanized products of the rubber compositions of Examples 29 to 34, in which a predetermined amount of an adsorption filler was mixed, rubber foaming due to zinc monomethacrylate was not observed as a result of visual observation.

Specific forms have been described in the above Examples. It should be understood that the Examples are only illustrative, and are not limitedly interpreted. Furthermore, changes belonging to the equivalent scope of the claims are all within the scope of the present invention.

The vibration-isolating rubber composition is preferably used as a vibration-isolating material of an engine mount, a stabilizer bush, a suspension bush, or the like, all of which are used in the body of an automobile or the like. Besides, the vibration-isolating rubber composition can also be used in applications of damping (vibration control) devices and seismic isolators, such as a vibration damper of a hard disk of a computer, a vibration damper of general household electric appliances such as a washing machine, and a damping wall and a vibration damper (vibration controller) for architectural structures in the fields of architecture and houses.

1. A vibration-isolating rubber composition, comprising:
components (A) and (B) below and components (C) and (D) below,
(A) diene rubber;
(B) silica having all the properties (a), (β), and (γ):
(α) a silanol group density of the silica surface of 3.0 groups/nm² or more as calculated by the Sears titration method,
(β) an average particle diameter of 10 μm or less, and
(γ) a BET specific surface area of 15 to 60 m²/g;
(C) a silane coupling agent represented by general formula (1): 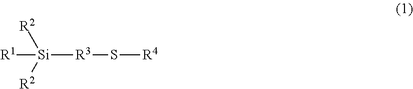
wherein R² represents an alkyl polyether group —O—(R⁵—O)ₘ—R⁶, where m is 1 to 30 on average, R⁵s in the number m of repetitions may be the same or different and are each a hydrocarbon group having 1 to 30 carbon atoms, and R⁶ is a monovalent alkyl, alkenyl, aryl, or aralkyl group having at least 11 carbon atoms,
wherein two R²s may be the same or different, and are each the same as R¹, an alkyl group having 1 to 12 carbon atoms, or an R⁷O group where R⁷ is H, a methyl, ethyl, propyl, (R⁸)₃Si group, where R⁸ is an alkyl or alkenyl group having 1 to 30 carbon atoms, or a monovalent alkyl, alkenyl, aryl, or aralkyl group having 9 to 30 carbon atoms,
wherein R³ is at least one divalent hydrocarbon group having 1 to 30 carbon atoms and selected from the group consisting of aliphatic, aromatic, and mixed aliphatic-aromatic groups, and
wherein R⁴ is H, CN, or (C═O)—R⁹, where R⁹ is at least one monovalent hydrocarbon group having 1 to 30 carbon atoms and selected from the group consisting of aliphatic, aromatic, and mixed aliphatic-aromatic groups; and
(D) at least one selected from the group consisting of zinc monomethacrylate, 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, N-acryloyloxyethyl hexahydrophthalimide, isobornyl methacrylate, tetrahydrofurfuryl acrylate, 2-phenoxyethyl methacrylate, ethoxylated (2) hydroxyethyl methacrylate, and isodecyl methacrylate,
wherein the amount of the component (B) added is 10 to 100 parts by weight relative to 100 parts by weight of the component (A).

2. The vibration-isolating rubber composition according to claim 1, wherein the component (D) is a combination of zinc monomethacrylate and a mono(meth)acrylate selected from 2-tert-butyl-6-(3-tert-butyl-2-hydroxy-5-methylbenzyl)-4-methylphenyl acrylate, stearyl methacrylate, tridecyl methacrylate, polypropylene glycol monomethacrylate, phenol EO-modified acrylate, nonylphenol EO-modified acrylate, isobornyl methacrylate, tetrahydrofurfuryl acrylate, 2-phenoxyethyl methacrylate, and isodecyl methacrylate.

3. The vibration-isolating rubber composition according to claim 2, wherein the amount of the silane coupling agent added as the component (C) is 0.5 to 10 parts by weight relative to 100 parts by weight of the component (A).

4. The vibration-isolating rubber composition according to claim 3, wherein the amount of the component (D) added is 0.5 to 10 parts by weight relative to 100 parts by weight of the component (A).

5. The vibration-isolating rubber composition according to claim 4, further comprising a metal (meth)acrylate.

6. The vibration-isolating rubber composition according to claim 5, further comprising at least one adsorption filler selected from the group consisting of zeolite, sepiolite, and hydrotalcite.

7. A vulcanized product of the vibration-isolating rubber composition according to any one of claims 1 to 6.
